(19) United States
(12) Patent Application Publication
(10) Pub. No.: US 2007/0203815 A1
(43) Pub. Date: Aug. 30, 2007

(54) AGGREGATING TAX DATA AND FACILITATING TAX PAYMENTS

(76) Inventor: William Dean Maegerlein, Bloomington, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/675,603

(22) Filed: Feb. 15, 2007

Related U.S. Application Data
(60) Provisional application No. 60/743,297, filed on Feb. 15, 2006.

(51) Int. Cl. G07F 19/00

(52) U.S. Cl. 705/31

(57) ABSTRACT

A system is shown for aggregating tax data for parcels of real property that are subject to taxation in a plurality of governmental taxing jurisdictions. The data is aggregated by a service provider, who in turn provides the data to a variety of users using consistent or customized data formats. Some users make use of the data for reference, while others make payments on the tax accounts for the various parcels. The service provider charges some users a subscription fee for access to the data, and for some users adds a service charge when payments are made through the service provider based on the data.

### REFERENCE TO RELATED APPLICATIONS

This application claims priority to U.S. Provisional Patent Application No. 60/743,297, filed on Feb. 15, 2006, with title SYSTEM AND METHOD FOR AGGREGATING AND FACILITATING TAX PAYMENTS.

### FIELD OF THE INVENTION

The present invention relates to collection and dissemination of tax-related information. More specifically, the present invention relates to systems, methods, devices, and ways of doing business relating to the collection of data concerning amounts payable to the government, making that data available, collecting relevant payments, and engaging in related activities.

### BRIEF DESCRIPTION OF THE DRAWINGS

FIG. 1 is a block diagram showing relationships between county treasurers' offices and various tax information consumers.

FIG. 2 is a block diagram of an information distribution system.

FIG. 3 is a flowchart illustrating use of an exemplary website in connection with the system of FIG. 2.

FIG. 4 is a block diagram of a computer for use in connection with the system of FIG. 2.

FIG. 5 is a diagram showing the flow of funds in one method of doing business in connection with the system of FIG. 2.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, one form of the present invention is a computer system that accepts tax data from a plurality of government taxing entities, publishes the data in a consolidated package for those who can use it, and accepts payments on behalf of those taxing entities. Another form is a business method in which an entity collects tax account data from taxing entities, publishes it to subscribers in exchange for payment of subscription fees, and optionally shares a portion of the subscription revenue with the taxing entities and/or provides the service to the taxing entities without charge. Yet another form is a method including collecting tax account data from a governmental entity, publishing the collected data to potential payors, and collecting payments on at least two tax accounts from at least one of the potential payors.

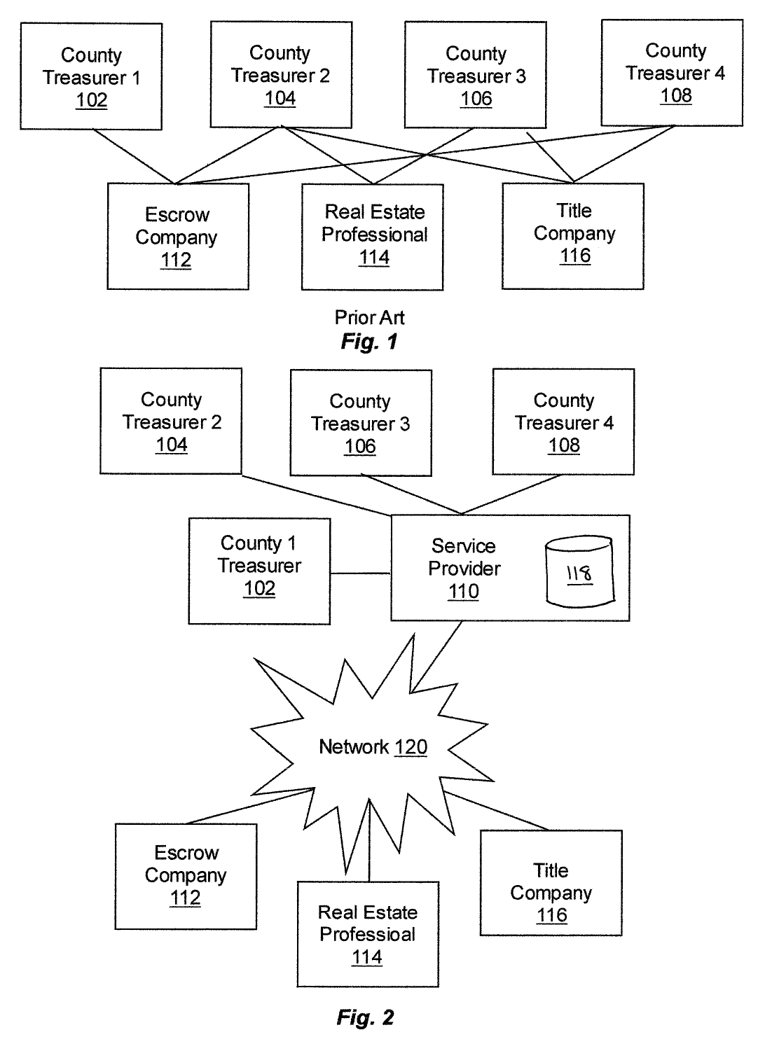

Relationships among parties in a current tax information exchange system are shown in FIG. 1. Each county treasurer's office 102, 104, 106, 108 maintains official records for the assessment and payment of property taxes in its respective county 1, 2, 3, or 4. As mortgage companies (not shown) collect escrow funds from homeowners (not shown), for example, they maintain a portion of the homeowners' payments in escrow accounts at an escrow company 112. Escrow company 112 is responsible for ensuring that sufficient funds are paid from the escrow accounts to the appropriate county treasurer's offices by the relevant deadlines to cover the tax liability associated with the mortgaged parcels of land.

To meet this responsibility for the many parcels associated with its many escrow accounts, escrow company 112 sends individual employees or contractors to each relevant county treasurer's office 102, 104, 108 to collect the available information about the parcels from each office. This individual provides a list of parcel identifiers to the county treasurer's office, and the treasurer provides information that might include, for example, the current amount due, the legal description, special assessments, delinquencies, and the like for each parcel. In many cases, an individual must physically visit the treasurer's office in each county in which the escrow company has properties.

In other cases, an escrow company may request from the county treasurer data for each parcel that the county shows to be associated with the escrow company. The county treasurer provides data for those parcels, but the escrow company must then reconcile the provided data against its own records to ensure that it pays taxes on all parcels for which it should, but does not pay taxes on parcels on which it should not. Furthermore, property transactions (sales, refinancing, etc.) that occur within about 30 days of the tax payment deadline are often not reflected in the data of either the escrow company or the county treasurer, so further requests must be made. The list of corrections needed following a first dispensation of data is called an “exception file.” The exception file is transmitted to the county treasurer's office, and a second batch of data is provided in return. It is often necessary to generate a second exception file and retrieve a third batch of data. Once all of the data is collected (or it is too close to the deadline to wait any longer), the escrow company 112 pays each county treasurer's office amounts reflected in the data as owing for its parcels. The county treasurer's offices must manually process these payments, reconciling the tax accounts for parcels identified by the escrow company as being paid.

Other professionals also need up-to-date information regarding the property tax status of specific parcels of land. For example, real estate professionals 114 often practice in multiple counties, and often find it useful to have information about the tax status of various properties when advising their clients. This information is difficult for real estate professionals to acquire, however, so often they do without it.

Title and abstract companies 116, on the other hand, cannot do without correct and current tax data. These companies 116 must reliably retrieve this data for each title policy they issue, so they must interact often with various county treasurers' offices 104, 106, 108 using the information retrieval procedures described above.

Some embodiments of the present system will now be described with reference to FIGS. 2-5, and with continuing reference to certain parties identified in FIG. 1.

In one form of the present system, system 101 shown in FIG. 2, service provider 110 collects tax data for all parcels in counties 1, 2, 3, and 4 from county treasurers' offices 102, 104, 106, and 108, respectively. Service provider 110 accepts this data from the various county offices in the various file formats that the various offices provide, and preferably automates its import into an electronic data repository that stores tax data from all of these counties. As data in each county's records is updated with new delinquencies, assessments, property transactions, and tax payments, the respective county treasurer's office updates the electronic records of service provider 110 using manual or automated techniques, such as telephone calls, interactive voice response systems, database triggers, automated uploads of data at specified times or frequencies, and other data synchronization techniques as will occur to those skilled in the art.

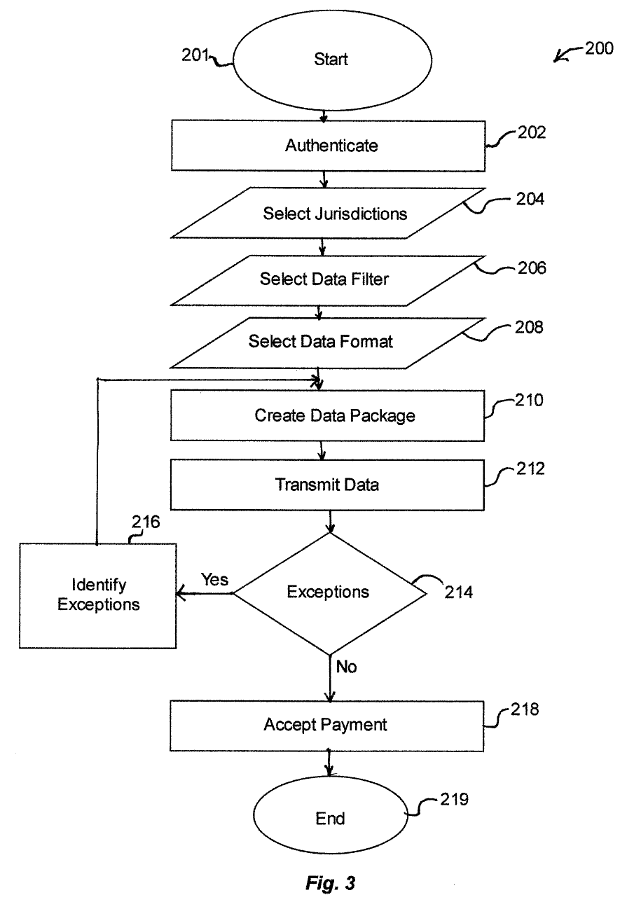

Service provider 110 makes this data available via network 120 (which may, for example, be the internet) to escrow company 112, real estate professionals 114, and title companies 116. As escrow company 112 prepares to pay taxes on the parcels it manages, it accesses the data via network 120. To do so in this example embodiment, escrow company 112 accesses a web site operated by service provider 110 and follows the process that will be shown in the flowchart in FIG. 3.

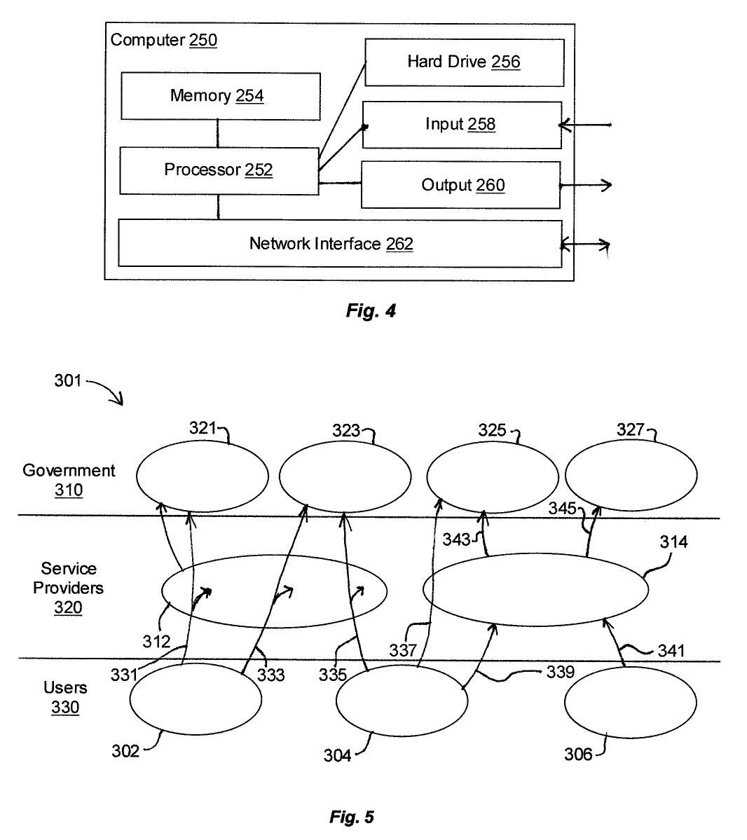

The data maintained by service provider 110 is preferably stored in a database 118. Database 118 conceptually represents one or more databases, which could take on any of many forms that will occur to those skilled in the art. As some examples, database 118 may comprise one or more logical databases, may be monolithic or distributed, may be housed in volatile memory, nonvolatile hard drives, or optical media, and may be of the relational, object-relational, flat, hierarchical, network, object-oriented, semistructured, associative, entity-attribute-value, or context models, to name several examples. In fact, database 118 in some embodiments is hosted on computer 250 and stored on hard drive 256 (see FIG. 4), though in other embodiments the host and/or storage is located elsewhere, or in a combination of local and remote locations.

The data retrieval and payment submission process 200 shown in FIG. 3 begins at Start point 201. The escrow company 112 authenticates itself to the computer of service provider 110 at block 202 for access control and billing purposes. At block 204, the escrow company 112 selects the jurisdictions for which it wants data, and optionally adds a filter at block 206. The jurisdiction selection in this example includes clicking on one or more counties within a particular state, for example, though other selection techniques may be available and used as will occur to those skilled in the art. Likewise, optional filters in various embodiments might selectively include or exclude parcels that (according to the records of the county treasurer) should be paid by a particular escrow company, have changed hands since a date certain or within a given number of days before the data request, have specified geographical characteristics, or other filters that will occur to those skilled in the art.

At block 208, the escrow company 112 selects a format for the data to be retrieved. In some embodiments, a predetermined set of formats are available, tailored for foreseen needs and circumstances of particular institutions. In other embodiments, service provider 110 makes only one data format available to all users of the system, so the selection is made by service provider 110. In yet other embodiments, service provider 110 infers a desired data format from the type of organization escrow company 112 is. In still other embodiments, escrow company 112 uses a web-based interface to select the file format and data fields to be transmitted.

Based on the jurisdiction(s), data filter, and file format selected at blocks 204, 206, and 208, respectively, service provider 110 constructs a data package that conforms to those selections at block 210. Service provider 110 transmits the data package to escrow company 112 at block 212. This file may be downloaded directly from the server(s) of service provider 110, sent as one or more web pages, transmitted as an attachment to an e-mail message, accessed via a link in an e-mail message, or transferred using some other method that will occur to one skilled in the art.

When escrow company 112 has received the requested data, it determines at block 214 whether there are any exceptions, such as parcels flagged in the data for it to pay, though the parcel has been sold and its tax should be paid by another entity; parcels not flagged in the data for it to pay, though its records reflect that it should pay the tax; parcels listed in the data as being subject to a delinquency; and the like. Escrow company 112 identifies these exceptions in a communication to service provider 110 at block 216, and a new data package reflecting the changes is created at block 210. In alternative embodiments, other methods are used to communicate exceptions and/or updates between escrow company 112 and service provider 110 (on behalf of the various county treasurers' offices).

In this embodiment, when escrow company 112 and service provider 110 settle upon the parcels for which escrow company 112 is to pay tax and the amount to be paid for each, escrow company 112 sends and service provider 110 accepts payment of that tax at block 218. In some of these embodiments, this payment is an automated clearing house (ACH) transaction, while in others it is a wire transfer, e-check, credit card transaction, or other form of payment that will occur to those skilled in the art. In some embodiments, the system prevents duplicate payment of tax on any particular parcel (such as when another entity has already paid the tax); in others, the system notifies the user when a requested payment has already been made, but allows the user to override the warning and submit a duplicate payment. Process 200 ends at End point 219.

Other users of system 101 follow analogous procedures to access and use the data that service provider 110 aggregates. For example, real estate professionals 114 access the computer(s) of service provider 110 via network 120 to obtain up-to-date tax records for single parcels being sold or purchased by their clients. Similarly, title companies 116 access the computer(s) of service provider 110 via network 120 to obtain up-to-date tax records for parcels upon which they are issuing title insurance policies.

To facilitate operation of process 200, service provider 110 maintains computing resources in one or more locations. Collectively, these computing resources have the functional parts shown as computer 250 in the block diagram in FIG. 4. Computer 250 includes processor 252, memory 254, and hard drive 256, as well as input interface 258, output interface 260, and network interface 262, as will be understood by those skilled in the art. Power, ground, clock, sensors, and other signals and circuitry are not shown for clarity, but will be understood and easily implemented by those who are skilled in the art.

Processor 252 is preferably a microcontroller or general purpose microprocessor that reads its program from memory 254. Processor 252 may be comprised of one or more components configured as a single unit. Alternatively, when of a multi-component form, processor 252 may have one or more components located remotely relative to the others. One or more components of processor 252 may be of the electronic variety defining digital circuitry, analog circuitry, or both. In one embodiment, processor 252 is of a conventional, integrated circuit microprocessor arrangement, such as one or more Quad-Core XEON processors from INTEL Corporation of 2200 Mission College Boulevard, Santa Clara, Calif., 95052, USA, or OPTERON processors from Advanced Micro Devices, One AMD Place, Sunnyvale, Calif., 94088, USA.

Output device interface 260 provides a video signal to a local display device (not shown), and may provide signals to one or more additional output devices such as LEDs, LCDs, or audio output devices, or a combination of types, though other output devices and techniques could be used as would occur to one skilled in the art. Likewise, optional input device 258 may include push-buttons, UARTs, IR and/or RF receivers, decoders, or other devices, as well as traditional keyboard and mouse devices. In alternative embodiments, one or more application-specific integrated circuits (ASICs), general-purpose microprocessors, programmable logic arrays, or other devices may be used alone or in combination as would occur to one skilled in the art.

Likewise, memory 254 and hard drive 256 can each include one or more types of data storage, such as solid-state electronic storage, magnetic storage, or optical storage, just to name a few types. By way of non-limiting example, memory 254 and hard drive 256 can each include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a recordable, rewritable, or read-only DVD or CD-ROM); a magnetically encoded hard disk, floppy disk, tape, or cartridge media; or a combination of any of these memory types. Also, memory 254 and hard drive 256 can each be volatile, nonvolatile, or a hybrid combination of volatile and nonvolatile varieties.

In various embodiments, processor 252 communicates with memory 254 and hard drive 256, which are encoded with programming instructions executable by processor 252 to achieve the actions attributed herein to service provider 110. This includes web server software and programming for the web server to accept data and updates from county treasurers' offices; serve static and dynamic web pages; establish, check, and revoke authentication credentials; compile, format, and transmit requested data to users; handle exceptions; accept and distribute payments; and other activities.

Turning to FIG. 5, a system 301 includes various cash flows that support a variety of methods of doing business in connection with various embodiments of the present invention. As discussed above, government entities in group 310 include a variety of entities that maintain property tax data, such as county treasurers' offices, 321, 323, 325, 327. Service providers group 320 includes two illustrated providers 312 and 314 that aggregate and normalize data from two or more government entities each. Users group 330 includes a variety of users 302, 304, 306 that use the aggregated data to investigate the status of parcels of property and/or pay tax liabilities.

In this illustration, service provider 312 collects a fee as part of tax payment transactions. Service provider 314, on the other hand, charges subscription fees to users for access to relevant data, but does not take payment in connection with tax payment transactions. In other embodiments, service providers offer both types of plans simultaneously, or might offer different plans for different types of access, or for different types of users, as will occur to those skilled in the art.

The hypothetical scenario illustrated in FIG. 5 shows an escrow company 302 that has received tax roll data from provider 312, then paying governmental entities 321 and 323 via provider 312. Part of each payment transaction 331, 333 is a fee paid to the service provider 312, while the remainder of the funds paid by escrow company 302 is paid to the governmental entity 321, 323. In these transactions, service provider 312 makes its services available at no charge to the governmental entities—the cost of the services is borne entirely by the users 302, 304 who benefit from the convenience of service. In the case of governmental entity 321, the contract with service provider 312 even provides that a portion of the service fee collected by service provider 312 is paid by service provider 312 to governmental entity 321. The arrangement between service provider 312 and governmental entity 323, on the other hand, includes no payment from service provider 312 to governmental entity 323.

Service provider 314 uses a subscription model for generating revenue in this hypothetical scenario. Service provider 314 collects subscription fee payments 339, 341 from users 304, 306 and pays access fees 343, 345 to governmental entities 325, 327, respectively. User 304 makes tax payment 337 to governmental entity 325 through service provider 314, but without any additional cost or fee being paid to service provider 314.

In alternative embodiments, service providers have uniform arrangements with all governmental entities with which they do business. In other embodiments, a service provider has an exclusive arrangement with the governmental entities with which it does business, while in still other embodiments, multiple service providers serve the same (or overlapping sets of) governmental entities.

In some embodiments, the system checks payments against the current amounts due for indicated parcels to reduce errors in payments, including those made by credit card or other means. In some embodiments, users of tax data can access accurate and up-to-date information without any human interaction and without significant delay. In many embodiments, the opportunities for human error are greatly reduced, avoiding overpayments, underpayments, duplicate payments, and other errors.

In some embodiments, data produced by the system is filtered and/or sorted per the user's request, or using a predetermined filter based on the user, a classification that the user is in, or on some other basis as will occur to those skilled in the art. In some of these embodiments, only delinquencies are sent, and in others only tax sale parcels are listed. In other embodiments, predetermined sets of fields and/or formats are offered for selection by users.

In still other embodiments, the service provider also provides call center services for one or more county treasurers' offices, such as the county treasurers' offices with which it works, to answer property tax-related questions and questions about the system. Some embodiments allow taxing entities to reduce staffing substantially by diverting a substantial portion of walk-in and telephone traffic to the on-line system, especially during peak tax seasons.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method of doing business as a service provider, the method comprising:
aggregating tax information from a plurality of governmental taxing entities; and
accepting payment from users to the service provider in exchange for providing electronic access to the aggregated data, without payment by the governmental taxing entities to the service provider.

2. The method of claim 1, wherein the payment includes a subscription fee that is independent of any tax payment transactions by the user.

3. The method of claim 1, wherein the tax information is property tax information.

4. The method of claim 3, wherein the governmental taxing entities are the property tax assessment offices in each of a plurality of counties.

5. The method of claim 1, wherein the payment includes a fee related to payment of taxes via the service provider.

6. The method of claim 1, wherein:
the aggregating step comprises accepting data from the governmental taxing entities in at least two data formats; and
the aggregated data to which users have electronic access is in a common output format.

7. The method of claim 6, further comprising:
offering a plurality of output format options to a user;
accepting the user's selection from among the plurality of output formats; and
providing the user with access to data from the plurality of governmental taxing entities in the selected output format.

8. The method of claim 6, further comprising:
identifying a class of users into which each user falls;
providing each user with access to data from the plurality of governmental taxing entities in an output format that is selected as a function of the user's class.

9. The method of claim 1, further comprising accepting a user specification of one or more criteria that limit the tax data provided to that user.

10. The method of claim 9, wherein the one or more criteria include at least one component of a property address, and the tax data provided includes only data related to property having addresses that match the at least one component.

11. The method of claim 9, wherein the one or more criteria include a payer identification, and the tax data provided includes only data related to property associated with the identified payer.

12. A system, comprising a processor and a memory in communication with the processor, the memory storing programming instructions executable by the processor to:
authenticate an authorized user; and
transmit property tax data to the user;
wherein the property tax data was received from a plurality of government entities that maintain tax information in a plurality of data formats, and
the transmission aggregates the property tax data into records having a consistent format.

13. The system of claim 12, wherein the authentication occurs via HTTP.

14. The system of claim 12, wherein the programming instructions are further executable to:
present a geographic area selection interface operable to accept selection by an authenticated user of one or more geographic areas of interest; and
limit the transmitted property tax data to the selected one or more geographic areas of interest.

15. The system of claim 12, wherein the programming instructions are further executable to:
present a property designation interface;
accept user identification of at least one property in the geographic area of interest; and
limit the transmitted property tax data to the identified at least one property.

16. The system of claim 15, wherein the programming instructions are further executable to accept payment of property tax on the at least one property.

17. The system of claim 12, wherein the programming instructions are further executable to accept payment by the user of property taxes for a plurality of parcels for which data was transmitted.

18. The system of claim 12, wherein the transmission is by download.

19. The system of claim 12, wherein the transmission is triggered by the user clicking a URL in an e-mail message.

20. The system of claim 12, wherein the programming instructions are further executable to:
present a property selection interface that accepts upload of a file;
limit the transmitted property tax data to the identified at least one property.

21. The system of claim 12, wherein the programming instructions are further executable to accept selection by a user of a data format for the transmission.

22. The system of claim 12, wherein the programming instructions are further executable to accept payment of property tax on at least one property.

23. The system of claim 22, wherein the programming instructions are further executable to prevent duplicate payments of tax on any individual property.

24. The system of claim 22, wherein the programming instructions are further executable to warn the user before accepting a payment by the user of tax on any individual property when the tax on the individual property has already been paid.

25. The system of claim 12, wherein the transmission is asynchronous.
